(19) United States
(12) Patent Application Publication
(10) Pub. No.: US 2015/0234978 A1
(43) Pub. Date: Aug. 20, 2015

(54) Cell Internal Defect Diagnosis

(71) Applicant: Mentor Graphics Corporation, Wilsonville, OR (US)

(72) Inventors: Huaxing Tang, Wilsonville, OR (US); Robert Brady Benware, Clackamas, OR (US); Friedrich Hapke, Winsen (DE); Wu-Tung Cheng, Lake Oswego, OR (US); Manish Sharma, Wilsonville, OR (US)

(73) Assignee: Mentor Graphics Corporation

(21) Appl. No.: 14/621,868

(22) Filed: Feb. 13, 2015

Related U.S. Application Data
(60) Provisional application No. 61/941,277, filed on Feb. 18, 2014.

(51) Int. Cl. G06F 17/50

(52) U.S. Cl. CPC G06F 17/5081; G06F 17/5009

(57) ABSTRACT

Various aspects of the disclosed technology relate to cell internal defect diagnosis techniques. Defect candidates are first determined based on path-tracing through a circuit design. Then, cell internal defect suspects are determined from the defect candidates based on simulating failing test patterns by using cell internal fault models. The defect candidate determination may be further based on simulating the failing test patterns by using conventional fault models. The cell internal defect suspect determination may be further based on simulating passing test patterns by using the cell internal fault models.

### RELATED APPLICATIONS

This application claims the benefit of U.S. Provisional Patent Application No. 61/941,277, filed on Feb. 18, 2014, and naming Huaxing Tang et al. as inventors, which application is incorporated entirely herein by reference.

### FIELD OF THE DISCLOSED TECHNIQUES

The presently disclosed techniques relates to the field of circuit testing and fault diagnosis technology. Various implementations of the disclosed techniques may be particularly useful for locating cell internal defects through diagnosis.

### BACKGROUND OF THE DISCLOSED TECHNIQUES

Traditionally scan diagnosis is used to determine the most likely faulty locations and fault types for a given failing device. The diagnosis results are used to guide physical failure analysis (PFA) to locate the defect and identify the root cause. High quality diagnosis results from advanced diagnosis algorithm like layout-aware diagnosis can help the failure analysis engineer pick the proper equipment and method to focus on a much smaller area, thus improving the PFA success rate by reducing the turnaround time and cost.

Recently scan diagnosis has been applied directly to yield analysis. Systematic yield limiters may be identified from volume diagnosis results through various techniques. For example, an iterative algorithm has been used to parse volume diagnosis results to overcome the inherent ambiguity. Combined with layout information, high-quality volume diagnosis results can lead to a successful yield analysis.

Typically, defects can be classified into two categories based on defect locations. A defect in a library cell is called a cell internal defect and a defect on interconnecting wires is called an interconnect defect. Recently, significant progress has been made in the area of interconnect defect diagnosis. This improvement in layout-aware diagnosis can dramatically improve the diagnosis resolution for interconnect defects, and reduce the PFA turnaround time and cost.

Efforts have been made to provide better accuracy and resolution for cell internal defects as well. In one approach, a transistor-level defect is first mapped into a gate-level defect, and then a conventional gate-level diagnosis tool is applied to the converted gate-level design to identify faulty gates and pinpoint faulty transistors. One disadvantage of this approach is that the success for identifying the real defects depends largely on the accuracy of the modified library cell model in representing all the realistic cell internal defects.

Another approach is based on excitation condition extraction. Defective cells are first determined by conventional gate-level diagnosis techniques. Then the failing excitation conditions and passing excitation conditions for interested cells are extracted from the test patterns. The failing excitation conditions are the logic value combinations on the inputs of the defective cell that can activate the internal defects, and propagate the effects to the cell outputs. The passing excitation conditions are the logic value combinations on the inputs that cannot excite or propagate the internal defect to the cell outputs.

Various techniques have been developed to derive cell internal defect candidates from the extracted excitation condition. In one of such techniques, an excitation condition table for stuck-open faults is correlated with a gate input sequence table to diagnose the cell internal defects with sequence dependent defect behavior. In another one, switch level simulation is first used to create a fault dictionary for cell internal faults, including bridges faults, stuck-at faults and stuck-open faults. Excitation conditions for suspect cells are matched against the pre-generated fault dictionary to come up with the final report.

The excitation condition extraction is, however, a non-trivial task, especially for widely used multi-cycle test patterns. The diagnosis accuracy for cell internal defects is low for simple passive excitation extraction. Active excitation condition extraction may improve the accuracy of extracted excitation conditions and thus increase the diagnosis accuracy by tracking the fault effect propagation paths, but the ambiguities of excitation conditions cannot be completely eliminated especially for multi-cycle test patterns. Also, while the defective cell may be located, the exact defect location within that cell cannot be determined.

Moreover, locating the defective cell could be challenging when multi-cycle patterns are used. It has been reported that for several industrial designs, the defective cell can't be found for 24%-40% of cell internal defects for multi-cycle test patterns. The reason is that the traditional logic diagnosis is based on a stuck-at fault model. A complex cell internal defect may have a non-stuck-at behavior (e.g., behaving as sa0 in one cycle and as sa1 in another cycle), which may cause unexplained test patterns and confuse the diagnosis algorithm. X-based simulation and suspect validation by simulating extracted excitation conditions, or a probabilistic diagnosis algorithm based on Bayes decision theory may be employed to address this issue.

Similar to the interconnect defect diagnosis, layout information for cell internal defects may be used to pinpoint the location of a cell internal defect. For example, cell internal defect candidates may be determined based on the layout information and then cell internal defect models may be derived by using a transistor-level simulator. The cell internal defect models are then compared with excitation conditions extracted by a conventional diagnosis tool for the failing and passing test patterns of a given failure file to determine cell internal defect suspects. The diagnosis resolution, however, may be affected by inaccuracies of the excitation conditions extracted by the conventional diagnosis tool.

### BRIEF SUMMARY OF THE DISCLOSED TECHNIQUES

Various aspects of the disclosed technology relate to cell internal defect diagnosis techniques. In one aspect, there is a method, executed by at least one processor of a computer, comprising: determining defect candidates based on path-tracing through a circuit design, wherein the path-tracing comprises probing from failing observation points into the circuit design; and determining cell internal defect suspects from the defect candidates based on simulating failing test patterns that generate failing values at the failing observation points by using cell internal fault models.

In another aspect, there are one or more non-transitory computer-readable media storing computer-executable instructions for causing one or more processors to perform a method, wherein the method comprises: determining defect candidates based on path-tracing through a circuit design, wherein the path-tracing comprises probing from failing observation points into the circuit design; and determining cell internal defect suspects from the defect candidates based on simulating failing test patterns that generate failing values at the failing observation points by using cell internal fault models.

The method recited above may further comprise: determining initial conventional defect suspects from the defect candidates based on simulating failing test patterns that generate failing values at the failing observation points by using conventional fault models; and determining conventional defect suspects from the initial conventional defect suspects based on simulating passing test patterns by using the conventional fault models. The method may still further comprise: determining symptoms by grouping the cell internal defect suspects and the conventional defect suspects.

The determining cell internal defect suspects may be further based on simulating passing test patterns by using the cell internal fault models. The conventional fault models may comprise stuck-at fault models. The cell internal fault models may be derived based on transistor-level simulation.

The determining defect candidates may be further based on simulating failing test patterns that generate failing values at the failing observation points by using conventional fault models. The determining defect candidates may be still further based on simulating passing test patterns by using the conventional fault models.

In still another aspect, there is a system, comprising: an initial defect candidate determination unit configured to determine defect candidates based on path-tracing through a circuit design, wherein the path-tracing comprises probing from failing observation points into the circuit design; and a cell internal defect suspect determination unit configured to determine cell internal defect suspects from the defect candidates based on simulating failing test patterns that generate failing values at the failing observation points by using cell internal fault models.

The initial defect candidate determination unit may comprise a conventional fault model-based failing pattern simulation unit. The initial defect candidate determination unit may further comprise a conventional fault model-based passing pattern simulation unit.

The system recited above may further comprise: a conventional fault model-based failing pattern simulation unit configured to determine initial conventional defect suspects from the defect candidates based on simulating failing test patterns that generate failing values at the failing observation points by using conventional fault models; and a conventional fault model-based passing pattern simulation unit configured to determine conventional defect suspects from the initial conventional defect suspects based on simulating passing test patterns by using the conventional fault models.

The system recited above may still further comprise: a symptom determination unit configured to determine symptoms by grouping the cell internal defect suspects and the conventional defect suspects.

Certain inventive aspects are set out in the accompanying independent and dependent claims. Features from the dependent claims may be combined with features of the independent claims and with features of other dependent claims as appropriate and not merely as explicitly set out in the claims.

Certain objects and advantages of various inventive aspects have been described herein above. Of course, it is to be understood that not necessarily all such objects or advantages may be achieved in accordance with any particular embodiment of the disclose techniques. Thus, for example, those skilled in the art will recognize that the disclose techniques may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 illustrates a programmable computer system with which various embodiments of the disclosed technology may be employed.

FIG. 2 illustrates an example of a diagnosis tool according to various embodiments of the disclosed technology

FIG. 3 illustrates a flowchart showing a process of cell internal defect diagnosis that may be implemented according to various examples of the disclosed technology.

FIG. 4 illustrates an example of a detailed implementation of the flow chart 300 combined with a conventional fault diagnosis process.

FIG. 5 illustrates an example of a yield analysis flow that incorporates the disclosed cell internal diagnosis technology.

### DETAILED DESCRIPTION OF THE DISCLOSED TECHNIQUES

### General Considerations

Various aspects of the disclosed technology relate to cell-aware fault diagnosis. In the following description, numerous details are set forth for the purpose of explanation. However, one of ordinary skill in the art will realize that the disclosed technology may be practiced without the use of these specific details. In other instances, well-known features have not been described in details to avoid obscuring the disclosed technology.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “determine” and “simulate” to describe the disclosed methods. Such terms are high-level abstractions of the actual operations that are performed. The actual operations that correspond to these terms will vary depending on the particular implementation and are readily discernible by one of ordinary skill in the art.

Also, as used herein, the term “design” is intended to encompass data describing an entire integrated circuit device. This term also is intended to encompass a smaller group of data describing one or more components of an entire device, however, such as a portion of an integrated circuit device. Still further, the term “design” also is intended to encompass data describing more than one microdevice, such as data to be used to form multiple microdevices on a single wafer.

### Illustrative Operating Environment

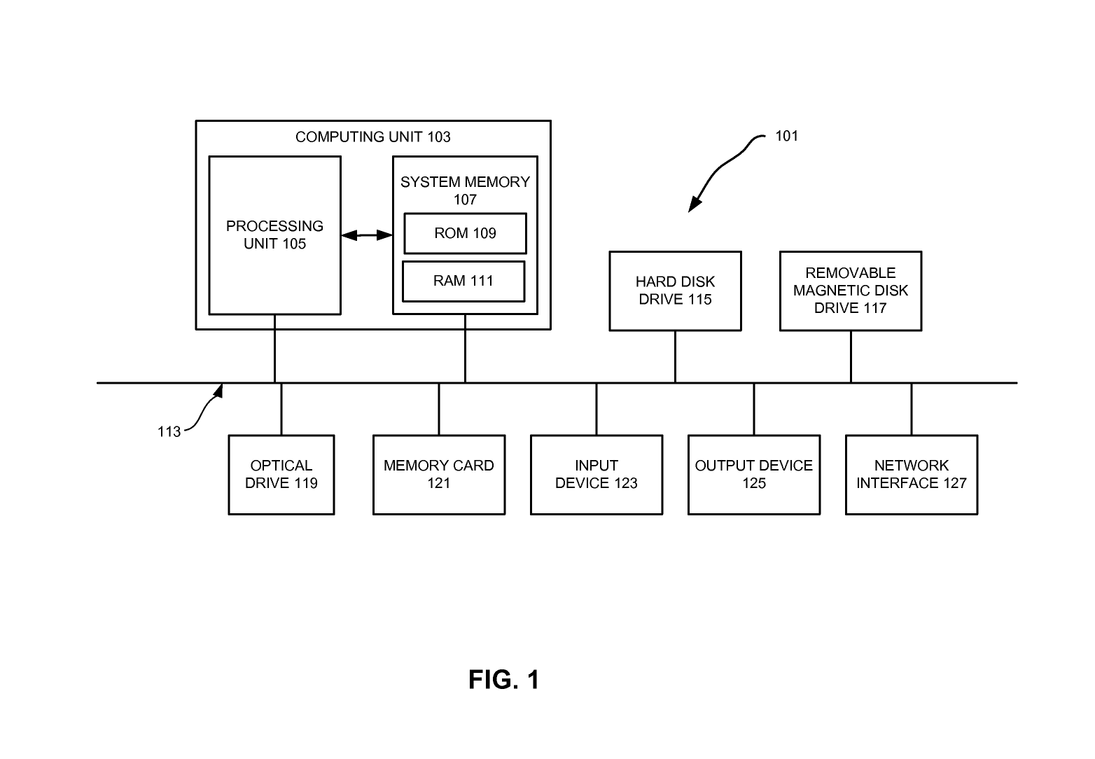

Various examples of the disclosed technology may be implemented through the execution of software instructions by a computing device, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a “hard” magnetic disk drive 115, a removable magnetic disk drive 117, an optical disk drive 119, or a flash memory card 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computer 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and it not intended to be limiting. Various embodiments of the disclosed technology may be implemented using one or more computing devices that include the components of the computer 101 illustrated in FIG. 1, which include only a subset of the components illustrated in FIG. 1, or which include an alternate combination of components, including components that are not shown in FIG. 1. For example, various embodiments of the disclosed technology may be implemented using a multi-processor computer, a plurality of single and/or multiprocessor computers arranged into a network, or some combination of both.

### Diagnosis Tools And Methods

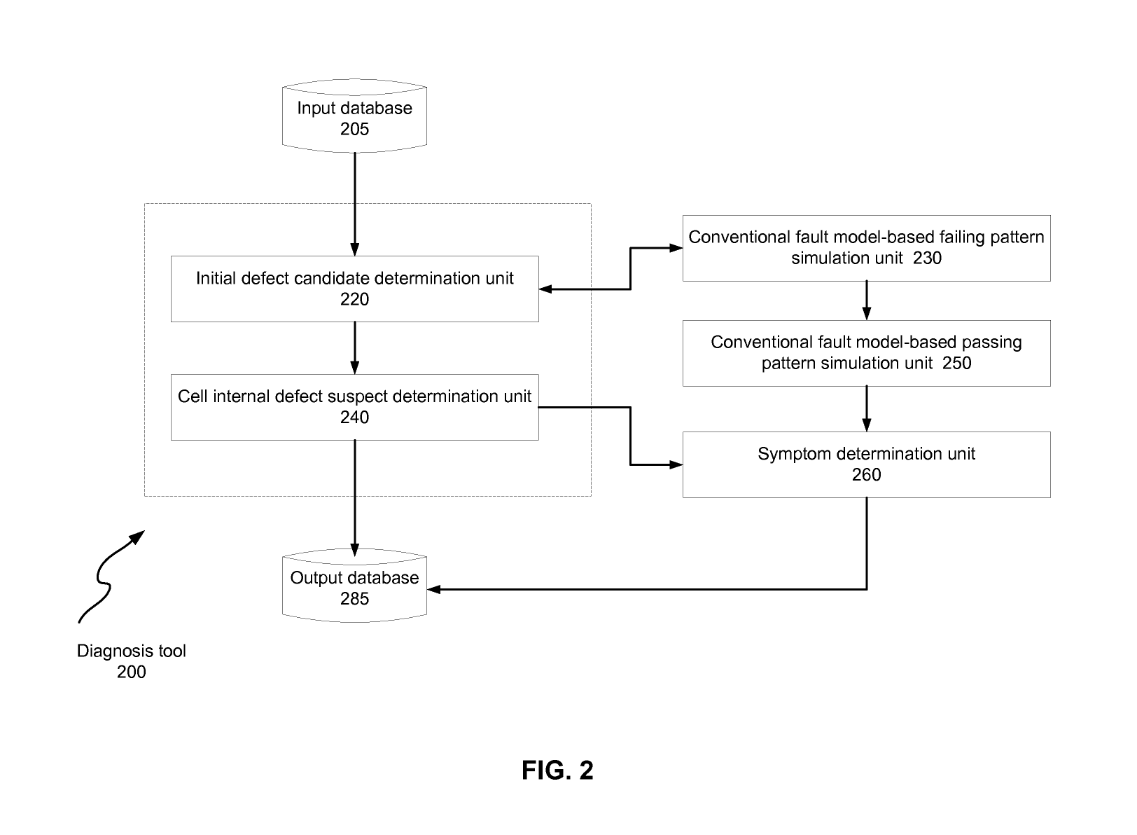

FIG. 2 illustrates an example of a diagnosis tool according to various embodiments of the disclosed technology. As seen in the figure, the diagnosis tool 200 includes two units: an initial defect candidate determination unit 220 and a cell internal defect suspect determination unit 240. Some implementations of the diagnosis tool 200 may cooperate with (or incorporate) one or more of a conventional fault model-based failing pattern simulation unit 230, a conventional fault model-based passing pattern simulation unit 250, a symptom determination unit 260, an input database 205, and an output database 285.

As will be discussed in more detail below, the initial defect candidate determination unit 220 determines defect candidates based on path-tracing through a circuit design, wherein the path-tracing comprises probing from failing observation points into the circuit design. The initial defect candidate determination unit 220 may incorporate the conventional fault model-based failing pattern simulation unit 230 and determine the defect candidates further based on simulating failing test patterns that generate failing values at the failing observation points by using conventional fault models. The conventional fault model-based passing pattern simulation unit 250 may also be incorporated in the initial defect candidate determination unit 220.

The cell internal defect suspect determination unit 240 determines cell internal defect suspects from the defect candidates based on simulating failing test patterns that generate failing values at the failing observation points by using cell internal fault models. Instead of being incorporated in the initial defect candidate determination unit 220, the conventional fault model-based failing pattern simulation unit 230 and the conventional fault model-based passing pattern simulation unit 250 may be operated in parallel with the cell internal defect suspect determination unit 240. The determined conventional interconnected defect suspects and cell internal defect suspects are merged and grouped into various symptoms by the symptom determination unit 260.

As previously noted, various examples of the disclosed technology may be implemented by a computing system, such as the computing system illustrated in FIG. 1. Accordingly, one or more of the initial defect candidate determination unit 220, the cell internal defect suspect determination unit 240, the conventional fault model-based failing pattern simulation unit 230, the conventional fault model-based passing pattern simulation unit 250, and the symptom determination unit 260 may be implemented by executing programming instructions on one or more processors in a computing system such as the computing system illustrated in FIG. 1. Correspondingly, some other embodiments of the disclosed technology may be implemented by software instructions, stored on a non-transitory computer-readable medium, for instructing one or more programmable computers/computer systems to perform the functions of one or more of the initial defect candidate determination unit 220, the cell internal defect suspect determination unit 240, the conventional fault model-based failing pattern simulation unit 230, the conventional fault model-based passing pattern simulation unit 250, and the symptom determination unit 260. As used herein, the term “non-transitory computer-readable medium” refers to computer-readable medium that are capable of storing data for future retrieval, and not propagating electro-magnetic waves. The non-transitory computer-readable medium may be, for example, a magnetic storage device, an optical storage device, a “punched” surface type device, or a solid state storage device.

It also should be appreciated that, while the initial defect candidate determination unit 220, the cell internal defect suspect determination unit 240, the conventional fault model-based failing pattern simulation unit 230, the conventional fault model-based passing pattern simulation unit 250, and the symptom determination unit 260 are shown as separate units in FIG. 2, a single computer (or a single processor within a master computer) may be used to implement two or more of these units at different times, or components of two or more of these units at different times.

With various examples of the disclosed technology, the input database 205 and the output database 285 may be implemented using any suitable computer readable storage device. That is, either of the input database 205 and the output database 285 may be implemented using any combination of computer readable storage devices including, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable storage devices may also include magnetic cassettes, magnetic tapes, magnetic disks or other magnetic storage devices, punched media, holographic storage devices, or any other non-transitory storage medium that can be used to store desired information. While the input database 205 and the output database 285 are shown as separate units in FIG. 2, a single data storage medium may be used to implement some or all of these databases.

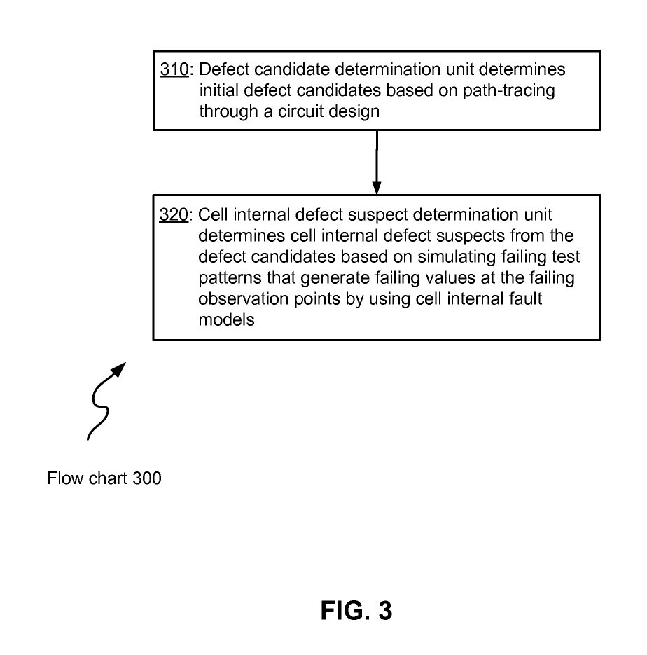

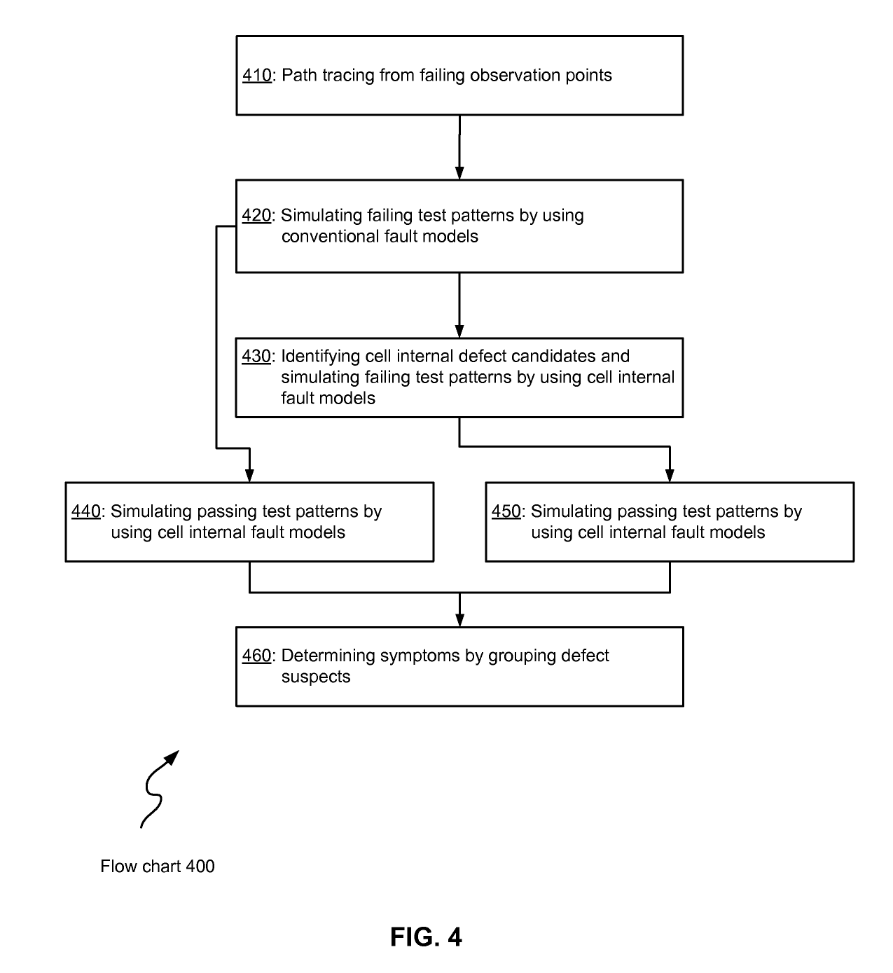

FIG. 3 illustrates a flowchart 300 showing a process of cell internal defect diagnosis that may be implemented according to various examples of the disclosed technology. FIG. 4 illustrates a flowchart 400 showing an example of a detailed implementation of the flow chart 300 combined with a conventional fault diagnosis process. For ease of understanding, methods of cell internal defect diagnosis that may be employed according to various embodiments of the disclosed technology will be described with reference to the diagnosis tool 200 illustrated in FIG. 2 and the flow charts 300 and 400 in FIGS. 3 and 4. It should be appreciated, however, that alternate implementations of a diagnosis tool may be used to perform the method of cell internal defect diagnosis in the flow chart 300 or the flow chart 400 according to various embodiments of the disclosed technology. In addition, it should be appreciated that implementations of the diagnosis tool 200 may be employed to implement methods of cell internal defect diagnosis according to different embodiments of the disclosed technology other than the one illustrated by the flow chart 300 in FIG. 3 or the flow chart 400 in FIG. 4.

Initially, in operation 310 of the flow chart 300, the initial defect candidate determination unit 220 determines defect candidates based on path-tracing through a circuit design. The path-tracing comprises probing from failing observation points into the circuit design. Either a primary output or a scan cell could serve as an observation point. An observation point is a failing observation point if the observed value is different from a good machine value. The failing observation points for a die are typically saved in a failure file.

The backward path tracing traces along the sensitized paths obtained based on the simulation results of the test patterns. The initial defect candidate determination unit 220 may employ a commercial fault diagnosis tool to perform the path-tracing operation. An example of such an electronic design automation tool is the Tessent® Diagnosis software tool available from Mentor Graphics Corporation of Wilsonville, Oreg.

The initial defect candidate determination may be further based on simulating failing test patterns that generate failing values at the failing observation points by using conventional fault models. As noted previously, the conventional fault model-based failing pattern simulation unit 230 may be incorporated into the initial defect candidate determination unit 220. The conventional fault model-based failing pattern simulation unit 230 simulates failing test patterns by using conventional fault models. The conventional fault models may comprise stuck-at fault models. Another category of commonly used conventional fault models are transition fault models. The simulation can eliminate some of the possible defect candidates obtained by the path tracing from further consideration. The conventional fault model-based failing pattern simulation unit 230 can also employs a commercial fault diagnosis tool to perform the simulation.

The initial defect candidate determination may be further still based on simulating passing test patterns by using the conventional fault models. Also as noted previously, the conventional fault model-based passing pattern simulation unit 250 may be incorporated into the initial defect candidate determination unit 220. The conventional fault model-based passing pattern simulation unit 250 simulates passing test patterns by using the conventional fault models. The simulation can further reduce the number of the defect candidates. A commercial fault diagnosis tool may be employed to perform the simulation.

Next, in operation 320, the cell internal defect suspect determination unit 240 determines cell internal defect suspects from the defect candidates based on simulating failing test patterns that generate failing values at the failing observation points by using cell internal fault models. The cell internal fault models may be derived based on transistor-level simulation such as SPICE. One example of the process for generating cell internal fault models comprises the following steps: 1) extracting parasitic resistors and capacitors from the layout design; 2) creating defects based on the extracted parasitic resistors and capacitors; 3) performing SPICE simulation for each of the defects; 4) generating fault models based on the simulation results; and 5) creating a layout property file for potential defect candidates that includes layout information for associated geometric elements. The determination cell internal defect suspects may be further based on simulating passing test patterns by using the cell internal fault models.

An example of combining the above process with a conventional fault diagnosis process is illustrated in the flowchart 400. In operation 410, defect candidates are determined by path tracing from failing observation points. In operation 420, Failing test patterns are simulated by using conventional fault models to determine initial conventional defect suspects from the defect candidates. In operation 430, initial cell internal defect suspects are first identified from initial conventional defect suspects based on the simulation results of the operation 420 and cell internal fault models, and then the initial cell internal defect suspects are simulated on the failing test patterns by using the cell internal fault models to determine intermediate cell internal defect suspects. In operation 440, the initial conventional defect suspects are simulated on the passing test patterns by using the conventional fault models to determine conventional defect suspects. Similarly, in operation 450, the intermediate cell internal defect suspects are simulated on the passing test patterns by using the cell internal fault models to determine cell internal defect suspects. Finally, in operation 460, the cell internal defect suspects and the conventional defect suspects are combined and grouped to determine symptoms. The cell internal defect suspects and the conventional defect suspects may also be scored and ranked.

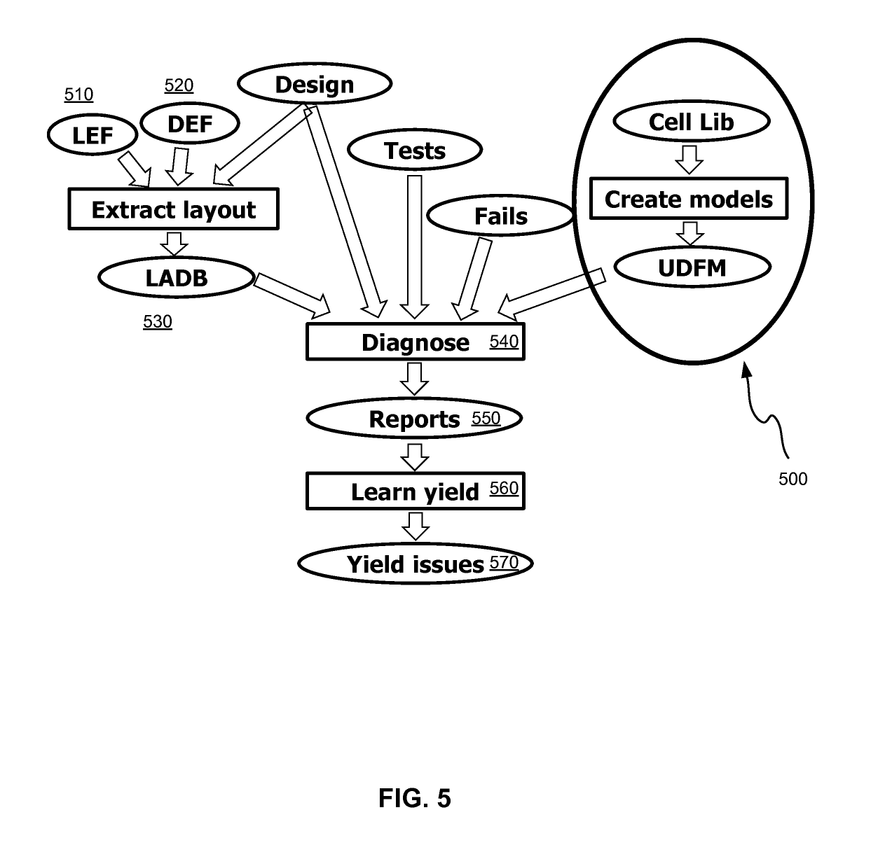

FIG. 5 illustrates an example of a yield analysis flow that incorporates the disclosed cell internal diagnosis technology. In a conventional flow (all excluding three boxes enclosed by an oval 500) a circuit, the layout information for interconnects is first extracted from design Library Exchange Format (LEF) files 510 and Design Exchange Format (DEF) files 520 and saved into a layout database (LADB) 530. During diagnosis 540, the LADB 530 is used to help pinpoint the potential defect location for interconnect defects, such as via opens and metal shorts. For cell internal defects, only the bounding boxes for the suspect cells will be reported, and no resolution inside the cell can be provided without using the cell layout and schematic information. After that, the volume diagnosis results 550 are fed into a statistical analysis engine 560 to identify the systematic yield issues 570.

To perform yield learning effectively for front-end-of-line (FEOL) defects, the diagnosis needs to provide better accuracy and resolution for cell internal defects. Similar to layout extraction for interconnects, one extra preprocessing step is needed to create defect models for library cells. That step is circled in the oval 500. Within this step, cell internal fault models are generated by using analog simulation (e.g. transistor level simulation) and store them in a single UDFM file with all the useful information for diagnosis, such as test conditions and layout information for each defect. This step needs to be done only once for a cell library, and the generated fault models in a UDFM file can be used for any design based on that cell library. This same UDFM file also may be used for generating cell-aware tests.

### CONCLUSION

While the disclosed techniques has been described with respect to specific examples including presently preferred modes of carrying out the disclosed techniques, those skilled in the art will appreciate that there are numerous variations and permutations of the above described systems and techniques that fall within the spirit and scope of the disclosed techniques as set forth in the appended claims. For example, while specific terminology has been employed above to refer to electronic design automation processes, it should be appreciated that various examples of the disclosed techniques may be implemented using any desired combination of electronic design automation processes.

What is claimed is:

1. A method, executed by at least one processor of a computer, comprising:
determining defect candidates based on path-tracing through a circuit design, wherein the path-tracing comprises probing from failing observation points into the circuit design; and
determining cell internal defect suspects from the defect candidates based on simulating failing test patterns that generate failing values at the failing observation points by using cell internal fault models.

2. The method recited in claim 1, wherein the determining defect candidates is further based on simulating failing test patterns that generate failing values at the failing observation points by using conventional fault models.

3. The method recited in claim 2, wherein the determining defect candidates is further based on simulating passing test patterns by using the conventional fault models.

4. The method recited in claim 1, wherein the determining cell internal defect suspects is further based on simulating passing test patterns by using the cell internal fault models.

5. The method recited in claim 1, further comprising:
determining initial conventional defect suspects from the defect candidates based on simulating failing test patterns that generate failing values at the failing observation points by using conventional fault models; and
determining conventional defect suspects from the initial conventional defect suspects based on simulating passing test patterns by using the conventional fault models.

6. The method recited in claim 5, further comprising:
determining symptoms by grouping the cell internal defect suspects and the conventional defect suspects.

7. The method recited in claim 1, wherein the conventional fault models comprise stuck-at fault models.

8. The method recited in claim 1, wherein the cell internal fault models are derived based on transistor-level simulation.

9. One or more non-transitory computer-readable media storing computer-executable instructions for causing one or more processors to perform a method, the method comprising:
determining defect candidates based on path-tracing through a circuit design, wherein the path-tracing comprises probing from failing observation points into the circuit design; and
determining cell internal defect suspects from the defect candidates based on simulating failing test patterns that generate failing values at the failing observation points by using cell internal fault models.

10. The one or more non-transitory computer-readable media recited in claim 9, wherein the determining defect candidates is further based on simulating failing test patterns that generate failing values at the failing observation points by using conventional fault models.

11. The one or more non-transitory computer-readable media recited in claim 10, wherein the determining defect candidates is further based on simulating passing test patterns by using the conventional fault models.

12. The one or more non-transitory computer-readable media recited in claim 9, wherein the determining cell internal defect suspects is further based on simulating passing test patterns by using the cell internal fault models.

13. The one or more non-transitory computer-readable media recited in claim 9, wherein the method further comprises:
determining initial conventional defect suspects from the defect candidates based on simulating failing test patterns that generate failing values at the failing observation points by using conventional fault models; and
determining conventional defect suspects from the initial conventional defect suspects based on simulating passing test patterns by using the conventional fault models.

14. The one or more non-transitory computer-readable media recited in claim 9, wherein the conventional fault models comprise stuck-at fault models.

15. The one or more non-transitory computer-readable media recited in claim 9, wherein the cell internal fault models are derived based on transistor-level simulation.

16. A system, comprising:
an initial defect candidate determination unit configured to determine defect candidates based on path-tracing through a circuit design, wherein the path-tracing comprises probing from failing observation points into the circuit design; and
a cell internal defect suspect determination unit configured to determine cell internal defect suspects from the defect candidates based on simulating failing test patterns that generate failing values at the failing observation points by using cell internal fault models.

17. The system recited in claim 16, wherein the initial defect candidate determination unit comprises a conventional fault model-based failing pattern simulation unit.

18. The system recited in claim 17, wherein the initial defect candidate determination unit further comprises a conventional fault model-based passing pattern simulation unit.

19. The system recited in claim 16, further comprising:
a conventional fault model-based failing pattern simulation unit configured to determine initial conventional defect suspects from the defect candidates based on simulating failing test patterns that generate failing values at the failing observation points by using conventional fault models; and
a conventional fault model-based passing pattern simulation unit configured to determine conventional defect suspects from the initial conventional defect suspects based on simulating passing test patterns by using the conventional fault models.

20. The system in claim 19, further comprising:
a symptom determination unit configured to determine symptoms by grouping the cell internal defect suspects and the conventional defect suspects.
